(19) United States
(12) Patent Application Publication
(10) Pub. No.: US 2006/0038738 A1
(43) Pub. Date: Feb. 23, 2006

(54) Wireless system having multiple antennas and multiple radios

(75) Inventor: Victor Shtrom, Sunnyvale, CA (US)

Correspondence Address: CARR & FERRELL LLP, 2200 GENG ROAD, PALO ALTO, CA, 94303, US

(73) Assignee: Video54 Technologies, Inc.

(21) Appl. No.: 11/190,288

(22) Filed: Jul. 26, 2005

Related U.S. Application Data
(60) Provisional application No. 60/602,711, filed on Aug. 18, 2004.
(60) Provisional application No. 60/603,157, filed on Aug. 18, 2004.
(60) Provisional application No. 60/630,499, filed on Nov. 22, 2004.
(60) Provisional application No. 60/693,698, filed on Jun. 23, 2005.

(51) Int. Cl. H01Q 3/24

(52) U.S. Cl. 343/876; 343/893

(57) ABSTRACT

A wireless system includes a circuit that couples one or more of a plurality of antenna elements to one or more of a plurality of radios. The plurality of antenna elements may comprise a plurality of modified dipoles or omnidirectional antennas coupled to one or more radios by a plurality of PIN diodes. The antenna elements may be configured by a controller of the wireless system to generate a pattern agile radiation pattern or a substantially omnidirectional radiation pattern. The plurality of antenna elements may be contained within a housing of the wireless system or may be conformal to the housing.

### CROSS-REFERENCE TO RELATED APPLICATIONS

This application claims priority to and incorporates by reference U.S. Provisional Application No. 60/602,711 (Atty. Docket PA2823PRV) titled “Planar Antenna Apparatus for Isotropic Coverage and QoS Optimization in Wireless Networks,” filed Aug. 18, 2004; U.S. Provisional Application No. 60/603,157 (Atty. Docket PA2824PRV) titled “Software for Controlling a Planar Antenna Apparatus for Isotropic Coverage and QoS Optimization in Wireless Networks,” filed Aug. 18, 2004; U.S. Provisional Application No. 60/630,499 (Atty. Docket PA2894PRV) titled “Method and Apparatus for Providing 360 degree Coverage via Multiple Antenna Elements Co-Located with Electronic Circuitry on a Printed Circuit Board Assembly,” filed Nov. 22, 2004; and U.S. Provisional Application No. 60/693,698 (Atty. Docket PA3341PRV) titled “Control of Wireless Network Transmission Parameters,” filed Jun. 23, 2005. This application is related to co-pending U.S. application Ser. No. 11/022,080 (Atty. Docket PA2894US) titled “Circuit Board having a Peripheral Antenna Apparatus with Selectable Antenna Elements,” filed Dec. 23, 2004; U.S. application Ser. No. 11/010,076 (Atty. Docket PA2823US) titled “System and Method for an Omnidirectional Planar Antenna Apparatus with Selectable Elements,” filed Dec. 9, 2004; and U.S. application Ser. No. 11/041,145 (Atty. Docket PA2868US) titled “System and Method for a Minimized Antenna Apparatus with Selectable Elements,” filed Jan. 21, 2005, the disclosures of which are incorporated by reference as if set forth fully herein.

### BACKGROUND OF INVENTION

1. Field of the Invention

The present invention relates generally to wireless communications, and more particularly to a wireless system having multiple antennas and multiple radios.

2. Description of the Prior Art

In communications systems, there is an ever-increasing demand for higher data throughput and a corresponding drive to reduce interference that can disrupt data communications. For example, in an IEEE 802.11 network, an access point (i.e., base station) communicates data with one or more remote receiving nodes (e.g., a network interface card of a laptop computer) over a wireless link. The wireless link may be susceptible to interference from other access points and stations (nodes), other radio transmitting devices, changes or disturbances in the wireless link between the access point and the remote receiving node, and so on. The interference may be such to degrade the wireless link, for example by forcing communication at a lower data rate, or may be sufficiently strong to completely disrupt the wireless link.

One method for reducing interference in the wireless link between the access point and the remote receiving node is to provide several omnidirectional antennas in a “diversity” scheme. For example, a common configuration for the access point comprises a radio transceiver coupled via a switching network to two physically separated omnidirectional “whip” antennas. The access point may select one of the omnidirectional antennas by which to maintain the wireless link. Because of the separation between the omnidirectional antennas, each antenna experiences a different signal environment, and each antenna contributes a different interference level to the wireless link. The switching network couples the radio transceiver to whichever of the omnidirectional antennas experiences the least interference in the wireless link.

A problem with the two or more whip antennas is that the whips typically comprise metallic wands attached to the access point that can be bent or broken off of the access point relatively easily. A further problem with whip antennas is that because the physically separated antennas may still be relatively close to each other, each of the antennas may experience similar levels of interference. In other words, only a relatively small reduction in interference may be gained by switching from one omnidirectional antenna to another omnidirectional antenna.

A multiple-input, multiple-output (“MIMO”) architecture in the access point and the receiving node can be a method for improving spectral efficiency of a wireless link. In a typical MIMO approach, multiple signals (two or more radio waveforms) are generated and transmitted in a single channel between the access point and the remote receiving node.

FIG. 1 illustrates an exemplary access point 100 for MIMO having two parallel baseband-to-RF transceiver (“radio”) chains 110 and 111 in the prior art. Data received into the access point 100 (e.g., from a router connected to the Internet, not shown) is encoded by a data encoder 105 into baseband signals for transmission to a MIMO-enabled remote receiving node (not shown). The parallel radio chains 110 and 111 generate two radio waveforms by digital-to-analog (D/A) conversion and upconversion, typically with an oscillator driving a mixer and filter. Each radio chain 110 and 111 is respectively connected to an omnidirectional antenna 120 and 121. Typically, the omnidirectional antennas 120 and 121 are spaced as far as possible apart from each other, or at different polarizations and mounted to a housing of the access point 100. The two radio waveforms are simultaneously transmitted, affected by various multipath perturbations between the access point 100 and the MIMO-enabled remote receiving node, and then received and decoded by appropriate receiving circuits in the remote receiving node. Common MIMO systems today utilize up to three radios on the transmit side, and in the future, larger numbers of radios are expected to be implemented for increased spectral efficiency.

The potential for breakage of omnidirectional whip antennas noted above is exacerbated as MIMO systems incorporate increasing numbers of radios and associated antennas. For example, a 3-radio MIMO system includes at least 3 antennas. Such a large number of antennas exponentially increases the probability that one or more of the antennas may be damaged in use or in handling.

Further, the large number of antennas can make the access point appear as an unsightly “antenna farm.” The antenna farm is particularly unsuitable for home consumer applications, because large numbers of antennas with necessary separation can require an increase in the overall size of the access point, which most consumers desire to be as small and unobtrusive as possible.

### BRIEF DESCRIPTION OF THE FIGURES

The present invention will now be described with reference to drawings that represent a preferred embodiment of the invention. In the drawings, like components have the same reference numerals. The illustrated embodiment is intended to illustrate, but not to limit the invention. The drawings include the following figures:

FIG. 1 illustrates an exemplary access point for MIMO having two parallel baseband-to-RF transceiver (“radio”) chains in the prior art;

FIG. 2 illustrates a wireless system having multiple antennas and multiple radios, in one embodiment in accordance with the present invention;

FIG. 3A depicts antenna driving elements on the first layer of the substrate of the antenna apparatus of FIG. 2, in one embodiment in accordance with the present invention;

FIG. 3B illustrates the second and third layers of the substrate including a ground component of the antenna apparatus, in one embodiment in accordance with the present invention;

FIGS. 4A and 4B illustrate the circuit for coupling one or more of the radio frequency feed ports to one or more of the antenna driving elements of FIGS. 3A and 3B, in one embodiment in accordance with the present invention; and

FIGS. 5A and 5B illustrate the circuit for coupling one or more of the radio frequency feed ports to one or more of the antenna driving elements of FIGS. 3A and 3B, in an alternative embodiment in accordance with the present invention.

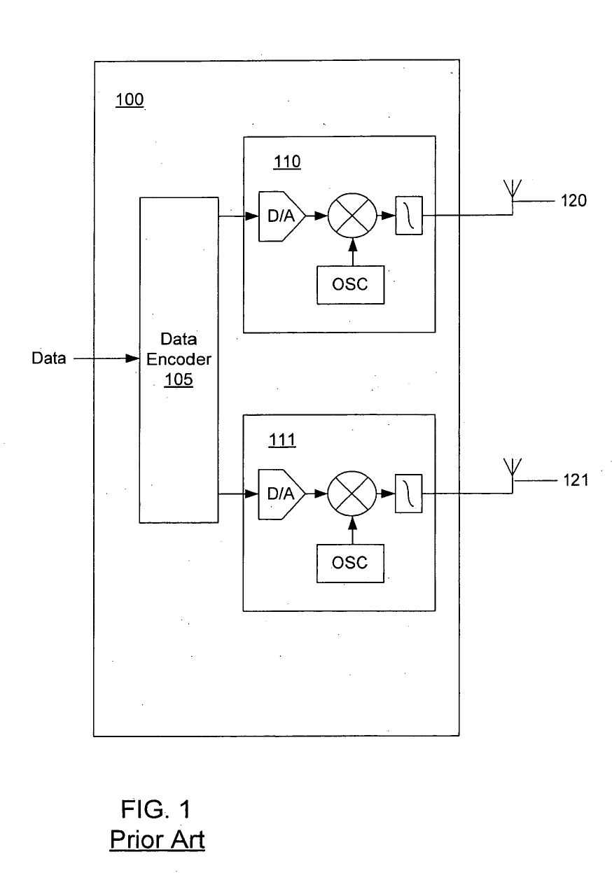

### SUMMARY

A system comprises a first transmitter, a second transmitter, an antenna apparatus comprising a plurality of antenna elements, and a circuit configured to couple the first transmitter to a first group of the plurality of antenna elements or the second transmitter to a second group of the plurality of antenna elements. The first group may be configured to radiate in a different pattern as compared to a radiation pattern of the second group. An output signal of the first transmitter may be of substantially the same center frequency and bandwidth as an output signal of the second transmitter. The antenna apparatus may be configured to be contained within a housing of the system, or may be essentially conformal to a housing of the system. The circuit may include PIN diodes to switch the first transmitter or the second transmitter to one or more of the plurality of antenna elements.

A method comprises generating a first radio signal, generating a second radio signal, selecting a first group of antenna elements of an antenna apparatus having a plurality of antenna elements with which to transmit the first radio signal, selecting a second group of antenna elements of the antenna apparatus with which to transmit the second radio signal, and coupling the first radio signal to the first group and the second radio signal to the second group. The first group may include one or more antenna elements included in the second group of antenna elements. Selecting the first group and the second group may comprise providing increased spatial and pattern diversity between the transmitted first radio signal and the transmitted second radio signal.

An antenna system comprises a first port configured to be coupled to a first transmitter, a second port configured to be coupled to a second transmitter, a plurality of antenna elements, and a circuit configured to couple the first port or the second port to one or more of the plurality of antenna elements. The circuit may be further configured to couple the first port and the second port to one or more of the plurality of antenna elements, and may include switching at RF with a plurality of PIN diodes. The plurality of antenna elements may comprise a planar antenna apparatus. The circuit may be cabled to the plurality of antenna elements.

### DETAILED DESCRIPTION

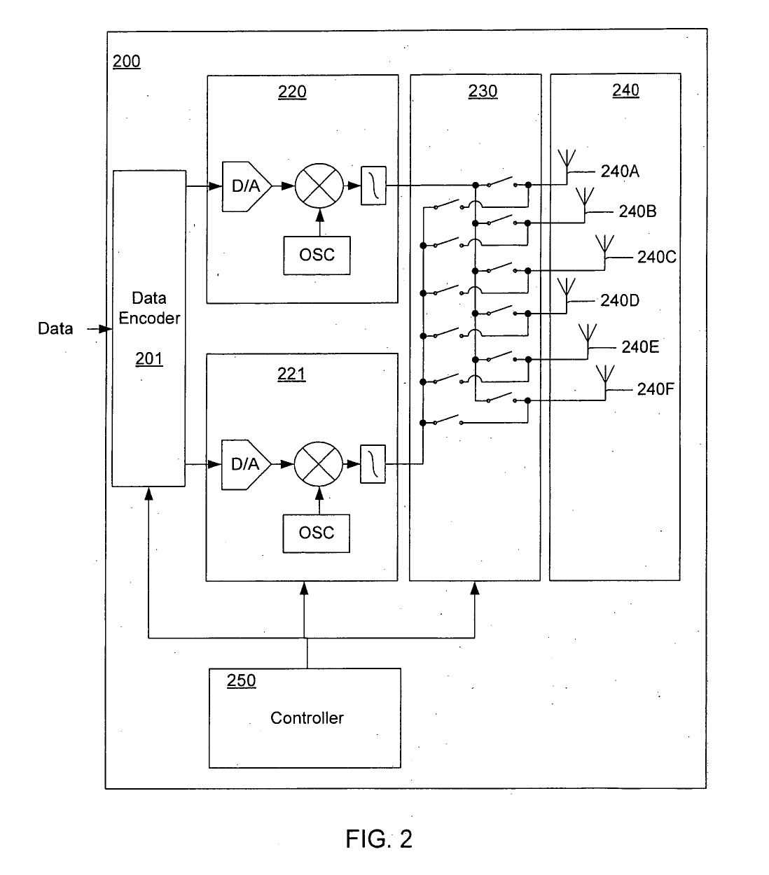

FIG. 2 illustrates a wireless system 200 having multiple antennas and multiple radios, in one embodiment in accordance with the present invention. The wireless system 200 may comprise, for example without limitation, a transmitter and/or a receiver, such as an 802.11 access point, an 802.11 receiver, a set-top box, a laptop computer, a television, a PCMCIA card, a remote control, a Voice Over Internet telephone, or a remote terminal such as a handheld gaming device. For example, the wireless system 200 may comprise an access point for communicating to one or more MIMO-compatible remote receiving nodes (not shown) over a wireless link, for example in an 802.11 wireless network.

Typically, the wireless system 200 may receive data (e.g., video data) from a router connected to the Internet (not shown), and the wireless system 200 may transmit the video data to one or more of the remote receiving nodes (e.g., set-top boxes, not shown) for display on a TV or video display. The wireless system 200 may also form a part of a wireless local area network by enabling communications among several remote receiving nodes. Although the disclosure will focus on a specific embodiment for the wireless system 200, aspects of the invention are applicable to a wide variety of appliances, and are not intended to be limited to the disclosed embodiment. For example, although the wireless system 200 may be described as transmitting to the remote receiving node, the wireless system 200 may also receive data from the remote receiving node.

The wireless system 200 includes a data encoder 201 for formatting data into an appropriate format for transmission to the remote receiving node via parallel radios 220 and 221. The data encoder 201 comprises data encoding elements such as spread-spectrum (or Orthogonal Frequency Division Multiplex, “OFDM”) encoding mechanisms and demultiplexers to generate baseband data streams in the appropriate format (e.g., 802.11g). The data encoder 201 may include, for example, hardware and/or software elements for converting video data received into the wireless system 200 (e.g., from a router coupled to the Internet) into data packets compliant to the IEEE 802.1 in format.

The radios 220 and 221 comprise transmitter or transceiver elements configured to up-convert the baseband data streams from the data encoder 201 to radio (RF) signals. The radios 220 and 221 thereby establish and maintain the wireless link. The radios 220 and 221 may comprise direct-to-RF upconverters or heterodyne upconverters, for example, for generating a first RF signal and a second RF signal, respectively. Generally, the first and second RF signals are at the same center frequency and bandwidth but may be offset in time or otherwise space-time coded.

The wireless system 200 further includes a circuit (e.g., switch network) 230 for coupling the first and second RF signals from the parallel radios 220 and 221 to an antenna apparatus 240 having a plurality of antenna elements 240A-F. In some embodiments, the antenna elements 240A-F comprise individually selectable antenna elements such that each antenna element 240A-F may be electrically selected (e.g., switched on or off). By selecting various combinations of the antenna elements 240A-F, the antenna apparatus 240 may form a “pattern agile” or reconfigurable radiation pattern. In some embodiments, if certain or substantially all of the antenna elements 240A-F are switched on, the antenna apparatus 240 forms an omnidirectional radiation pattern. Alternatively, the antenna apparatus 240 may form various directional radiation patterns, depending upon which of the antenna elements 240A-F are turned on.

The wireless system 200 also includes a controller 250 coupled to the data encoder 201, the radios 220 and 221, and the circuit 230 via a control bus 255. The controller 250 comprises hardware (e.g. microprocessor and logic) and/or software elements to control the operation of the wireless system 200.

In general principle of operation, the controller 250 may select a particular configuration of antenna elements 240A-F that minimizes interference over the wireless link to the remote receiving device. If the wireless link experiences interference, for example due to other radio transmitting devices, or changes or disturbances in the wireless link between the wireless system 200 and the remote receiving device, the controller 250 may select a different configuration of selected antenna elements 240A-F via the circuit 230 to change the resulting radiation pattern and minimize the interference. For example, the controller 250 may select a configuration of selected antenna elements 240A-F corresponding to a maximum gain between the wireless system 200 and the remote receiving device. Alternatively, the controller 250 may select a configuration of selected antenna elements 240A-F corresponding to less than maximal gain, but corresponding to reduced interference in the wireless link.

The controller 250 may also transmit a data packet using a first subgroup of antenna elements 240A-F coupled to the radio 220, and simultaneously send the data packet using a second group of antenna elements 240A-F coupled to the radio 221. Further, the controller 250 may change the group of antenna elements 240A-F coupled to the radios 220 and 221 on a packet-by-packet basis. Methods performed by the controller 250 for a single radio having access to multiple antenna elements are further described in U.S. application Ser. No. ______ (Atty. Docket PA2881US) titled “System and Method for Transmission Parameter Control for an Antenna Apparatus with Selectable Elements,” filed Jul. 12, 2005, which is commonly assigned as the present application and hereby incorporated by reference. These methods are applicable to the controller 250 having control over multiple antenna elements and multiple radios as described herein.

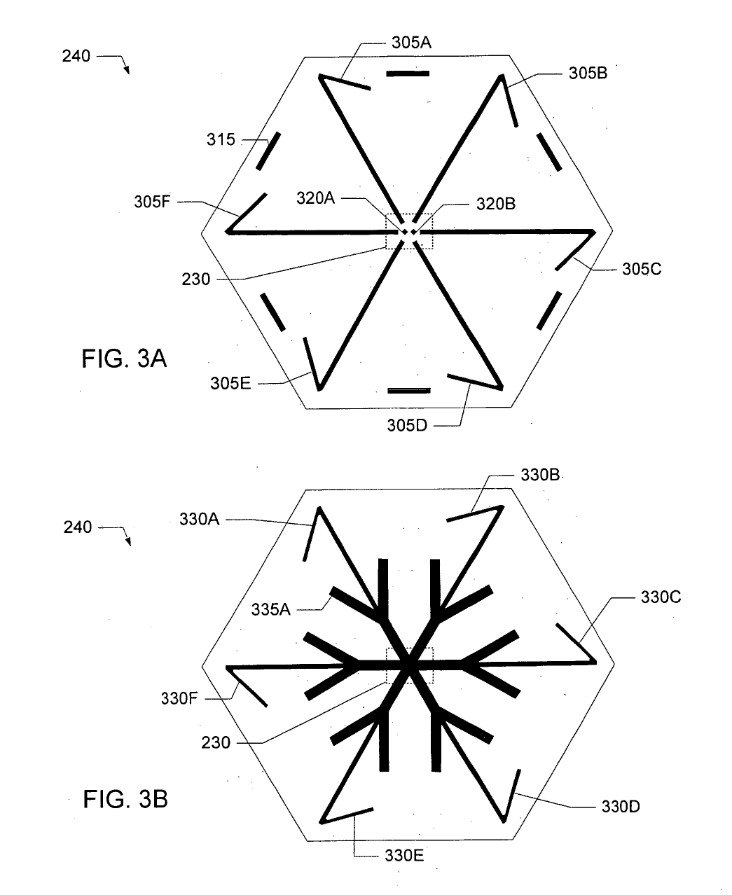

FIG. 3A and FIG. 3B illustrate the antenna apparatus 240 of FIG. 2, in one embodiment in accordance with the present invention. Various embodiments, as well as further explanation of the antenna apparatus 240, are described further in co-pending US utility application Ser. Nos. 11/022,080 and 11/010,076. The present disclosure will focus on the antenna apparatus 240 as disclosed in FIGS. 3A and 3B, although various embodiments of the antenna apparatus 240 as disclosed in the co-pending applications may be utilized in accordance with the teachings of the present disclosure to realize a wireless system having multiple antennas and multiple radios.

The antenna apparatus 240 of this embodiment includes a substrate having four layers of copper or other RF-conductive material separated by dielectric materials. In some embodiments, the substrate comprises a PCB such as copper on FR4, Rogers 4003, or other dielectric material.

FIG. 3A depicts antenna driving elements 305A-F on the first layer of the substrate of the antenna apparatus 240 of FIG. 2, in one embodiment in accordance with the present invention. The first layer includes the two radio frequency feed ports 320A and 320B, six bent dipole antenna driving elements 305A-F, and optionally one or more directors 315 (only one director 315 labeled for clarity). Although six antenna driving elements 305A-F are depicted, more or fewer antenna driving elements are contemplated. Although the antenna driving elements 305A-F are oriented to form a hexagonal shaped substrate, other shapes are contemplated. Further, although the antenna driving elements 305A-F form a radially symmetrical layout about the radio frequency feed ports 320, a number of non-symmetrical layouts, rectangular layouts, and layouts symmetrical in only one axis are contemplated. Furthermore, the antenna driving elements 305A-F need not be of identical dimension, although depicted as such in FIG. 3A.

FIG. 3B illustrates the second and third layers of the substrate including a ground component of the antenna apparatus 240, in one embodiment in accordance with the present invention. Portions (e.g., the portion 330A) of the ground component are configured to form arrow-shaped bent dipoles in conjunction with the antenna driving elements 305A-F of FIG. 3A. The resultant bent dipole (e.g., the portion 330A of the ground component in conjunction with the antenna driving element 305A) can be considered as the antenna element 240A of FIG. 2. Similarly, the other portions 330B-F of the ground component in conjunction with the antenna driving elements 305B-F can be considered as the antenna driving elements 240B-F of FIG. 2.

In the embodiment of FIG. 3B, Y-shaped reflectors 335 (only the reflector 335A is labeled for clarity) may be included in the ground component to increase gain and broaden a frequency response (i.e., bandwidth) of the bent dipoles of the antenna apparatus 240. For example, in some embodiments, the antenna apparatus 240 is designed to operate over a frequency range of about 2.4 GHz to 2.4835 GHz, for wireless LAN in accordance with the IEEE 802.11 standard. The reflectors 335 broaden the frequency response of each bent dipole to about 300 MHz to 500 MHz. The combined operational bandwidth of the antenna apparatus 240 resulting from coupling more than one of the antenna driving elements 305A-F to the radio frequency feed ports 320A and/or 320B is less than the bandwidth resulting from coupling only one of the antenna driving elements 305A-F to the radio frequency feed ports 320A and/or 320B.

For example, with four antenna driving elements 305A, 305C, 305D, and 305F coupled to the radio frequency feed port 320A, the combined frequency response of the antenna apparatus 240 is about 90 MHz. In some embodiments, coupling more than one of the antenna driving elements 305A-F to one or more of the radio frequency feed ports 320 maintains a match with less than 10 dB return loss over 802.11 wireless LAN frequencies, regardless of the number of antenna driving elements 305A-F that are switched on.

In the embodiment of FIGS. 3A and 3B, the antenna elements 240A-F provide a directional radiation pattern substantially in the plane of the antenna apparatus 240. For example, the antenna element 240A provides a generally cardiod radiation pattern opposite in orientation from the radiation pattern provided by the antenna element 240D.

It will be understood by persons of ordinary skill that the dimensions of the individual components of the antenna apparatus 240 (e.g., the antenna driving element 305A and the portion 330A of the ground component) depend upon a desired operating frequency of the antenna apparatus 240. The dimensions of the individual components may be established by use of RF simulation software, such as IE3D from Zeland Software of Fremont, Calif.

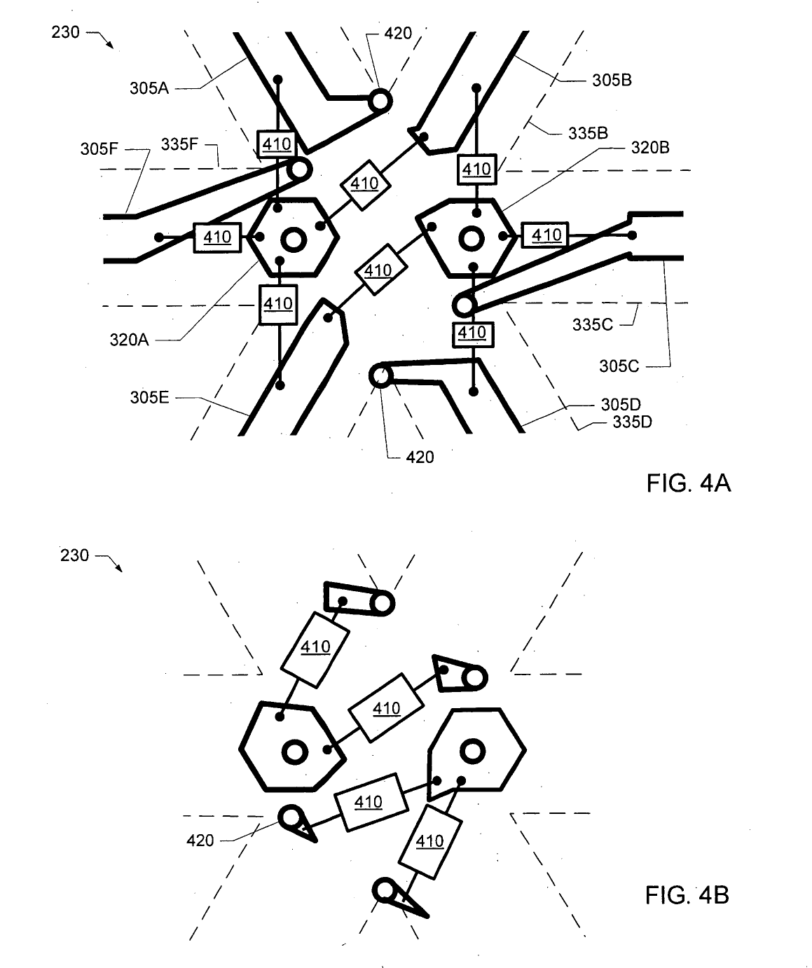

As described further with respect to FIGS. 4A and 4B, the circuit 230 (shown as a dashed rectangle in FIGS. 3A and 3B) couples one or more of the radio frequency feed ports 320A and 320B to one or more of the antenna elements 240A-F. The radio frequency feed ports 320A and 320B are configured to receive RF signals from and/or transmit RF signals to the radios 220 and 221 of FIG. 2, respectively, for example via coaxial RF cables (not shown). Although only two radio frequency feed ports 320A and 320B are depicted, more than two radio frequency feed ports are contemplated for use with more than two radios (e.g. transmitters).

FIGS. 4A and 4B illustrate the circuit 230 for coupling one or more of the radio frequency feed ports 320A and 320B to one or more of the antenna driving elements 305A-F of FIGS. 3A and 3B, in one embodiment in accordance with the present invention. FIG. 4A shows detail of the circuit 230 on the first layer (on the same layer as the antenna driving elements 305A-F) of the substrate of FIG. 3A. FIG. 4B shows detail of the circuit 230 on the fourth layer of the substrate. Portions of the ground component of FIG. 3, on the second and third layers of the substrate, are shown as dashed lines. In some embodiments, the third layer of the substrate (the ground reference for the fourth layer) is not the same configuration as the second layer (the ground reference for the antenna driving elements 305A-F).

The circuit 230 of this embodiment comprises multiple RF switches 410 between the radio frequency feed ports 320A and 320B and the antenna driving elements 305A-F. The RF switches 410 are depicted in outline form to enhance understanding of the PCB traces (thick lines) included in the circuit 230 which couple one or more of the antenna driving elements 305A-F to one or more of the radio frequency ports 320A and 320B when the particular RF switch 410 is enabled.

On the first layer, as depicted in FIG. 4A, the radio frequency feed ports 320A and 320B include pads for soldering one end of the RF switches 410. On the first and fourth layers, the PCB traces of the circuit 230 include vias 420 (not all vias 420 labeled for clarity) that interconnect traces on different layers. Also included are vias (not labeled) that connect the radio frequency feed ports 320A and 320B on the first and fourth layers.

Not shown in FIGS. 4A and 4B are antipads (clearance areas) preventing unwanted connections between layers. For example, the layers of the ground component include antipads of typically 25 mils clearance around the vias 420.

In some embodiments, the RF switches 410 comprise PIN diodes. Other embodiments of the RF switches 410 comprise GaAs FETs or other RF switching devices. The PIN diodes comprise single-pole single-throw switches to switch each antenna element 240 either on or off (i.e., couple or decouple each of the antenna driving elements 305A-F to either or both of the radio frequency feed ports 320A and 320B). In the embodiment of FIGS. 4A and 4B, twelve PIN diodes are included in the circuit 230, so that the two radio frequency ports 320A and/or 320B can be switched to one or more of the six antenna driving elements 305A-F.

A series of control signals (not shown) is used to bias each PIN diode. For biasing the PIN diodes, the circuit 230 of FIGS. 4A and 4B includes a DC-blocking capacitor (not shown) in line with each PIN diode, such that when the control signal is applied to the appropriate antenna driving element 305A-F and biased low, the PIN diode is turned on. With the PIN diode forward biased and conducting a DC current, the PIN diode is on, and the corresponding antenna element 240 is on. With the diode reverse biased, the PIN diode is off.

In some embodiments, the RF switches 410 comprise one or more single-pole multiple-throw switches. In some embodiments, one or more light emitting diodes (not shown) are included in the circuit 230 as a visual indicator of which of the antenna driving elements 305A-F is on or off. For example in one embodiment, a light emitting diode is placed in series with each PIN diode so that the light emitting diode is lit when the corresponding antenna driving element 305A-F is selected.

One advantage of the layout of the circuit 230 of FIGS. 4A and 4B is that the RF switches 410 may be readily placed and soldered into the circuit 230 by well-known manufacturing methods. Because of the vias 420, the RF switches 410 are configured in a manner that prevents the RF switches 410 from having to be stacked or otherwise oriented in a less-manufacturable manner. In other words, with the particular layout of FIGS. 4A and 4B, the twelve RF switches 410 are laid out such that any of the six antenna driving elements 305A-F may be electrically coupled to one or more of the two radio frequency feed ports 320A and 320B with no need for stacking of the RF switches 410.

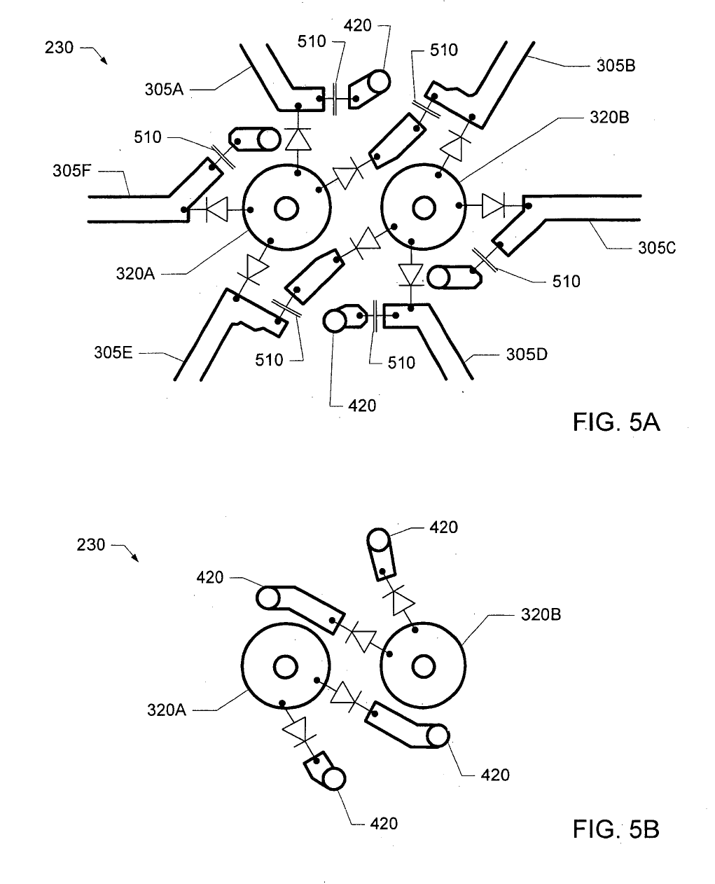

FIGS. 5A and 5B illustrate the circuit 230 for coupling one or more of the radio frequency feed ports 320A and 320B to one or more of the antenna driving elements 305A-F of FIGS. 3A and 3B, in an alternative embodiment in accordance with the present invention. FIG. 5A shows detail of the circuit 230 on the first layer (on the same layer as the antenna driving elements 305A-F) of the substrate of FIG. 3A. FIG. 5B shows detail of the circuit 230 on the fourth layer of the substrate. Portions of the ground component of FIGS. 3A and 3B are not shown for improved legibility. The RF switches of FIGS. 4A and 4B are depicted schematically as diodes and are not labeled for improved legibility.

On the first layer of the substrate, as shown in FIG. 5A, DC blocking capacitors 510 (shown in schematic form) are provided in the circuit 230 for switching of the RF switches. In this embodiment, the DC blocking capacitors 510 are used for biasing the RF switches in the circuit 230. When a control signal (not shown) is applied to the appropriate antenna driving element 305A-F and biased low, the corresponding RF switch is turned on. With the RF switch forward biased and conducting a DC current, the RF switch is on, and the corresponding antenna element 240 is on. With the diode reverse biased, the RF switch is off.

In some embodiments, the antenna components (e.g., the antenna driving elements 305A-F and the ground component) are formed from RF conductive material, separate from the circuit 230. For example, the antenna elements 305A-F and the ground component may be formed from metal or other RF conducting foil. Rather than being provided on the substrate as shown in FIGS. 3A and 3B along with the circuit 230, the antenna components may be conformally mounted to or etched onto the housing of the wireless system 200. In such embodiments, the circuit 230 comprises a separate structure from the antenna driving elements 305A-F. The circuit 230 may be mounted on a relatively small PCB that is electrically coupled to the antenna driving elements 305A-F, for example by RF coaxial cables. In some embodiments, the circuit 230 PCB is soldered directly to the antenna driving elements 305A-F.

An advantage of the antenna apparatus 240 of FIGS. 2-5 is that the antenna elements (e.g., the antenna driving elements 305A-F) are each individually selectable for each of the radios 220 and 221 and may be switched on or off to form various combined radiation patterns for the wireless system 200. For example, the controller 250 of the wireless system 200 communicating over a wireless link to a remote receiving node may select a particular configuration of selected antenna elements 240A-F that minimizes interference over the wireless link.

The controller 250 may determine a first subset of selected antenna elements 240A-F to use with the first radio 220, and a second subset of selected antenna elements 240A-F to use with the second radio 221. The first subset may have one or more antenna elements 240A-F in common with the second subset (i.e., one or more of the antenna elements 240A-F are contained in the first subset and the second subset, in which case the subsets overlap). The first subset may be entirely the same as the second subset (i.e., the first subset contains the same antenna elements 240A-F as are contained in the second subset). Alternatively, the first subset may be completely different from the second subset such that the first subset has no overlap with the second subset.

In one embodiment, in order to minimize the number of control signals needed to select the appropriate antenna elements 240A-F for each of the radios 220 and 221, the circuit 230 is configured such that selecting one subset of antenna elements 240A-F for the first radio 220 automatically selects a second subset for the second radio 221. For example, the circuit 230 may be configured such that selecting the antenna elements 240A, 240B, and 240C for the first radio 220 causes a different subset of antenna elements 240D, 240E, and 240F, to be selected as the second subset. In some embodiments, the circuit 230 contains combinatorial logic (e.g., lookup tables) such that selecting a particular subset of antenna elements 240A-F for the first radio 220 causes an associated second subset to be chosen for the second radio 221.

If the wireless link experiences interference, for example due to other radio transmitting devices, or changes or disturbances in the wireless link between the wireless system 200 and the remote receiving node, the controller 250 may select a different configuration of selected antenna elements 240A-F for the radios 220 and 221 to change the radiation pattern of the antenna apparatus 240 and minimize the interference in the wireless link. The controller 250 may change the radiation pattern of the antenna apparatus 240 on a packet-by-packet basis, and may select different radiation patterns for the radio 220 and the radio 221. For example, the controller 250 may select first and second subsets by which to transmit a first packet pair. The controller 250 may then select third and fourth subsets for the radios 220 and 221 by which to transmit a second packet pair. The third and fourth subsets may be overlapping, the same, or different as the first and second subsets, respectively.

The controller 250 may select a configuration of selected antenna elements 240A-F for the radios 220 and 221 corresponding to a maximum gain between the system and the remote receiving node. Alternatively, the system may select a configuration of selected antenna elements 240A-F corresponding to less than maximal gain, but corresponding to reduced interference. Alternatively, all or substantially all of the antenna elements 240A-F may be selected to form a combined omnidirectional radiation pattern.

A further advantage of the antenna apparatus 240 of FIGS. 3A-3B is that the RF signals generated are horizontally polarized. Horizontally polarized RF signals typically travel better indoors and network interface cards (NICs) for laptop computers are generally horizontally polarized. Providing horizontally polarized signals with the antenna apparatus 240 improves interference rejection (potentially, up to 20 dB) from RF sources that use commonly-available vertically polarized antennas.

Not shown in FIGS. 3-5 is that one or more elements of the antenna apparatus 240 may comprise an omnidirectional antenna, such as a whip antenna. Providing the omnidirectional antenna in conjunction with directional antenna elements may be advantageous, for example, by providing polarization diversity along with spatial and pattern diversity and/or omnidirectional coverage. In other words, by providing one or more omnidirectional antennas or other vertically polarized antennas in the antenna apparatus 240, the controller 250 of the wireless system 200 may select from among vertical polarization, horizontal polarization, as well as pattern agile or omnidirectional antenna patterns.

The invention has been described herein in terms of several preferred embodiments. Other embodiments of the invention, including alternatives, modifications, permutations and equivalents of the embodiments described herein, will be apparent to those skilled in the art from consideration of the specification, study of the drawings, and practice of the invention. The embodiments and preferred features described above should be considered exemplary, with the invention being defined by the appended claims, which therefore include all such alternatives, modifications, permutations and equivalents as fall within the true spirit and scope of the present invention.

What is claimed is:

1. A system, comprising:
a first transmitter;
a second transmitter;
an antenna apparatus comprising a plurality of antenna elements; and
a circuit configured to couple the first transmitter to a first group of the plurality of antenna elements or the second transmitter to a second group of the plurality of antenna elements.

2. The system of claim 1, wherein the first group is configured to radiate in a different pattern as compared to a radiation pattern of the second group.

3. The system of claim 1, wherein an output signal of the first transmitter is of substantially the same center frequency and bandwidth as an output signal of the second transmitter.

4. The system of claim 1, wherein the circuit is further configured to simultaneously couple the first transmitter and the second transmitter to one or more of the antenna elements.

5. The system of claim 1, wherein the circuit is further configured to couple the first transmitter to the first group and the second transmitter to the second group.

6. The system of claim 1, wherein the antenna apparatus is configured to be contained within a housing of the system.

7. The system of claim 1, wherein the antenna apparatus comprises a substantially planar substrate contained within a housing of the system.

8. The system of claim 1, wherein the antenna apparatus is configured to be essentially conformal to a housing of the system.

9. The system of claim 1, wherein the circuit is further configured to switch the first transmitter or the second transmitter to one or more of the plurality of antenna elements.

10. The system of claim 9, wherein the circuit comprises a plurality of RF switches.

11. A method, comprising:
generating a first radio signal;
generating a second radio signal;
selecting a first group of antenna elements of an antenna apparatus having a plurality of antenna elements with which to transmit the first radio signal;
selecting a second group of antenna elements of the antenna apparatus with which to transmit the second radio signal; and
coupling the first radio signal to the first group and the second radio signal to the second group.

12. The method of claim 11, wherein the first group includes one or more antenna elements included in the second group of antenna elements.

13. The method of claim 11, wherein the first group includes none of the antenna elements included in the second group of antenna elements.

14. The method of claim 11, wherein selecting the first group and the second group comprises providing increased spatial diversity between the transmitted first radio signal and the transmitted second radio signal.

15. The method of claim 11, wherein selecting the first group and the second group comprises providing increased pattern diversity between the transmitted first radio signal and the transmitted second radio signal.

16. The method of claim 11, wherein the first group provides a first radiation pattern, the second group provides a second radiation pattern, and coupling the first radio signal to the first group and the second radio signal to the second group comprises providing increased spatial diversity between the transmitted first signal and the transmitted second signal.

17. The method of claim 11, wherein generating the first radio signal, generating the second radio signal, selecting the first group, selecting the second group, and coupling the first radio signal to the first group and the second radio signal to the second group comprises transmitting a first packet pair, further comprising selecting a third group of antenna elements and a fourth group of antenna elements with which to transmit a second packet pair.

18. An antenna system comprising:
a first port configured to be coupled to a first transmitter;
a second port configured to be coupled to a second transmitter;
a plurality of antenna elements; and
a circuit configured to couple the first port or the second port to one or more of the plurality of antenna elements.

19. The antenna system of claim 18, wherein the circuit is further configured to couple the first port and the second port to one or more of the plurality of antenna elements.

20. The antenna system of claim 18, wherein the circuit is further configured to couple the first port or the second port to one or more of the plurality of antenna elements by switching at RF.

21. The antenna system of claim 18, wherein the circuit includes a plurality of PIN diodes configured to couple the first port or the second port to one or more of the plurality of antenna elements.

22. The antenna system of claim 18, wherein the plurality of antenna elements comprise a planar antenna apparatus.

23. The antenna system of claim 18, wherein the circuit is cabled to the plurality of antenna elements.
